(19) United States
(12) Patent Application Publication
(10) Pub. No.: US 2008/0091483 A1
(43) Pub. Date: Apr. 17, 2008

(54) Method and system for predicting the adoption of services, such as telecommunication services

(75) Inventors: Francois Blouin, Gatineau (CA); Michel Ouellette, Orleans (CA)

Correspondence Address: SMART & BIGGAR;P.O. BOX 2999, STATION D, 900-55 METCALFE STREET, OTTAWA, ON, K1P5Y6, US

(73) Assignee: Nortel Networks Limited

(21) Appl. No.: 11/529,221

(22) Filed: Sep. 29, 2006

(51) Int. Cl. G06F 9/44

(52) U.S. Cl. 705/7

(57) ABSTRACT

An innovative service modeling framework is provided that can be used to analyze and assess the business opportunities of existing and emerging telecommunication services. This forecasting model/tool provides an approach to assess current and future markets—thus lowering investment risks, ensuring better decisions and subsequently having a greater impact. The core of the framework relies on a novel forecasting model (based on the theory of diffusion or S-curves) that departs from typical models used by popular research firms. The enhanced diffusion model relies on multi-dimensional input parameters and can take into account the impact of disruptions, regulations, network readiness, user utility and other dynamics. The input parameters are modeled as a series of vectors and are used to represent perturbations to the model. These influence the behavior of the adoption rate process in more realistic way.

### FIELD OF THE INVENTION

The invention relates to the field of forecasting, more specifically to a method and system for predicting the adoption of services.

### BACKGROUND

Forecasting the adoption of existing and emerging goods is typically done using models based on the theory of diffusion.

The theory of diffusion describes the level of spread of goods among prospective adopters in terms of a simple mathematical function of time that has elapsed since the introduction of the goods. During diffusion there is a flow of adopters across different market segments, such as an untapped market, a potential market and a current market. Diffusion is usually expressed as a diffusion equation, such as the Bass, Gompertz, and FisherPry diffusion equations.

The adoption of goods over their lifetime is typically represented by a graph of their life cycle. Traditional forecasting models predict the adoption as having an “s”-shaped life cycle, known as an S-curve. An S-curve is characterized in an initial slow adoption. They are unknown to most prospective adopters, and only the experts or the curious adopt them. As the goods become more familiar, easier to use and more affordable, they are rapidly adopted. Finally, the S-curve ends with slow adoption and saturation.

FIG. 1 is a graph showing an S-curve 20 modeling the adoption of goods. The graph is plotted on a Cartesian plane defined by an x-axis representing time and a y-axis representing the number of adopters. The curve is defined by a start point 22, a constant diffusion rate, defined by diffusion parameter p 24 and an end-point 30 where the curve saturates at target market size K. Overall, S-curve 20 is S-shaped, symmetrical, and cumulatively increasing in number of adopters.

Not all diffusion processes are symmetrical. Symmetrical means that the point of inflection of the curve is at (Y-axis/2). For instance, the logistic equation is symmetrical whereas the Gompertz equation is not.

Diffusion models do not account for disruptions and/or market perturbation, but rather they are an idealistic model of growth.

Existing models are not very flexible in their parameterization. The p and K parameter for instance found in the BASS model are typically estimated (using different estimation procedures) by looking at the adoption rates of prior goods, in order to calibrate the diffusion model and forecast future adoption rate.

### SUMMARY OF THE INVENTION

According to one broad aspect, the invention provides a method for predicting an adoption of a service by subscribers over time, the method comprising the steps of: for each of at least one influence on the adoption defining at least one time vector that represents the influence; defining a diffusion equation that expresses a relationship between the adoption and a rate of change of the adoption and combining the diffusion equation and the at least one time vector for each influence to produce an enhanced diffusion model.

In some embodiments, at least one time vector is determined from a demand model, a supply model, or the supply model and the demand model.

In some embodiments, the at least one time vector includes at least one of a subscriber utility vector that represents the influence of subscriber demand on the adoption, a network utility vector that represents the influence of a provider's readiness to provide a service, an advantage vector that represents the influence of an advantage of the provider over another provider, a regulation vector that represents the influence of a regulation, and a disruption vector that represents the influence of a disruption.

In some embodiments, the diffusion equation is selected from a group consisting of the Bass, Gompertz, and FisherPry diffusion equations.

In some embodiments, defining the at least one time vector comprises: determining at least one factor that contributes to the influence; assigning to the at least one factor an impact score that represents the impact of the at least one factor on the adoption; defining a plurality of dates; assigning to a provider of the service at each date a time weight that represents how strongly the at least one factor contributes to the influence over time; and generating for the at least one factor and the provider at each date a factor-impact score that represents a weighting of the time weights against the impact score to produce the at least one time vector.

In some embodiments, defining the at least one time vector further comprises estimating the time weight based on at least one business consideration.

In some embodiments, defining the at least one time vector further comprises estimating the time weights based on the influence of a stakeholder.

In some embodiments, the diffusion equation has at least one parameter, and combining comprises making at least one parameter of the diffusion equation a function of time using at least one time vector.

In some embodiments, the at least one parameter comprises a saturation parameter K and a diffusion parameter p, at least one of which is a function of the at least one time vector.

In some embodiments, the saturation parameter K is a function of at least an advantage vector and a subscriber utility vector.

In some embodiments, the diffusion parameter p is a function of a subscriber utility vector, a network utility vector, an advantage vector, and a regulation vector.

In some embodiments, the method further comprises using the enhanced diffusion model to provide a prediction of a number of subscribers to a telecommunications service.

In some embodiments, the method further comprises using the enhanced diffusion model for at least one of: prioritizing business investment decisions, validating a customer business case, validating a product feature requirement, validating a network solution to ensure adequacy of quality of experience delivery, identifying an emerging service, identifying a rate of adoption, identifying a deployment timeline, identifying a service having the fastest adoption rate, identifying a factor having the most influence on adoption, building a cost model, project profits, predicting a time window for return on investment, and predicting when a late majority occurs.

In some embodiments, the method further comprises selecting the service from a class of services based on enabling factors, inhibiting factors, and disrupting factors.

In some embodiments, the method further comprises selecting the service based on an advantage of a provider over another provider on account of a type of content of the service.

According to another broad aspect, the invention provides a system for predicting the adoption of a service by subscribers over time comprising: a memory coupled to a processor, the processor configured to: for each of at least one influence on the adoption define at least one time vector that represents the influence; define a diffusion equation that expresses a relationship between the adoption and a rate of change of the adoption; and combine the diffusion equation and the at least one time vector for each influence to produce an enhanced diffusion model.

In some embodiments, the system is adapted to define the at least one time vector by: determining at least one factor that contributes to the influence; assigning to the at least one factor an impact score that represents the impact of the at least one factor on the adoption; defining a plurality of dates; assigning to a provider of the service at each date a time weight that represents how strongly the at least one factor contributes to the influence over time; and generating for the at least one factor and the provider at each date a factor-impact score that represents a weighting of the time weights against the impact score to produce the at least one time vector.

According to another broad aspect, the invention provides a computer readable medium on which is stored a set of instructions for predicting the adoption of a service by subscribers over time, which when executed performs steps comprising: for each of at least one influence on the adoption defining at least one time vector that represents the influence; defining a diffusion equation that expresses a relationship between the adoption and a rate of change of the adoption; and combining the diffusion equation and the at least one time vector for each influence to produce an enhanced model.

In some embodiments, defining the at least one time vector comprises: determining at least one factor that contributes to the influence; assigning to the at least one factor an impact score that represents the impact of the at least one factor on the adoption; defining a plurality of dates; assigning to a provid,mer of the service at each date a time weight that represents how strongly the at least one factor contributes to the influence over time; and generating for the at least one factor and the provider at each date a factor-impact score that represents a weighting of the time weights against the impact score to produce the at least one time vector.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a graph showing a conventional S-curve;

FIG. 2 is a graph comparing an example S-curve with actual historical data of a life cycle for various technologies;

FIG. 3 is a graph comparing an example S-curve with actual historical data for various consumer goods;

FIG. 4 is a graph showing an example basic S-curve in addition to actual historical data for a dial-up access service;

FIG. 5 is a flowchart of a method for predicting the adoption of a service by subscribers over time;

FIG. 6 is a flowchart of example steps for defining the time vector;

FIG. 7 shows a table of example variables implementing the steps in FIG. 6 for defining time vectors;

FIGS. 8A to 8F show tables having a format that is the same as FIG. 7 but featuring example values for defining time vectors for an IPTV service;

FIG. 9 is a table of example stakeholders that influence demand and/or supply for a services;

FIG. 10 is a conceptual block diagram showing the production of an enhanced diffusion model from a basic diffusion model and time vectors;

FIG. 11 is a graph showing a curve for historical data, a curve for a basic model and a curve for an enhanced model for the dial-up access service;

FIG. 12 is a graph showing a curve for historical data, a curve for a basic model and a curve for an enhanced model for a cable TV service;

FIG. 13 is a diagram of example factors for broadband access services;

FIGS. 14A to 14D contain a table of example broadband access services;

FIG. 15 is a block diagram of a system for predicting the adoption of a service by subscribers over time;

FIGS. 16A and 16B show an example of a generic service template; and

FIGS. 17A, 17B and 17C contain a service template filled in for the VoD service.

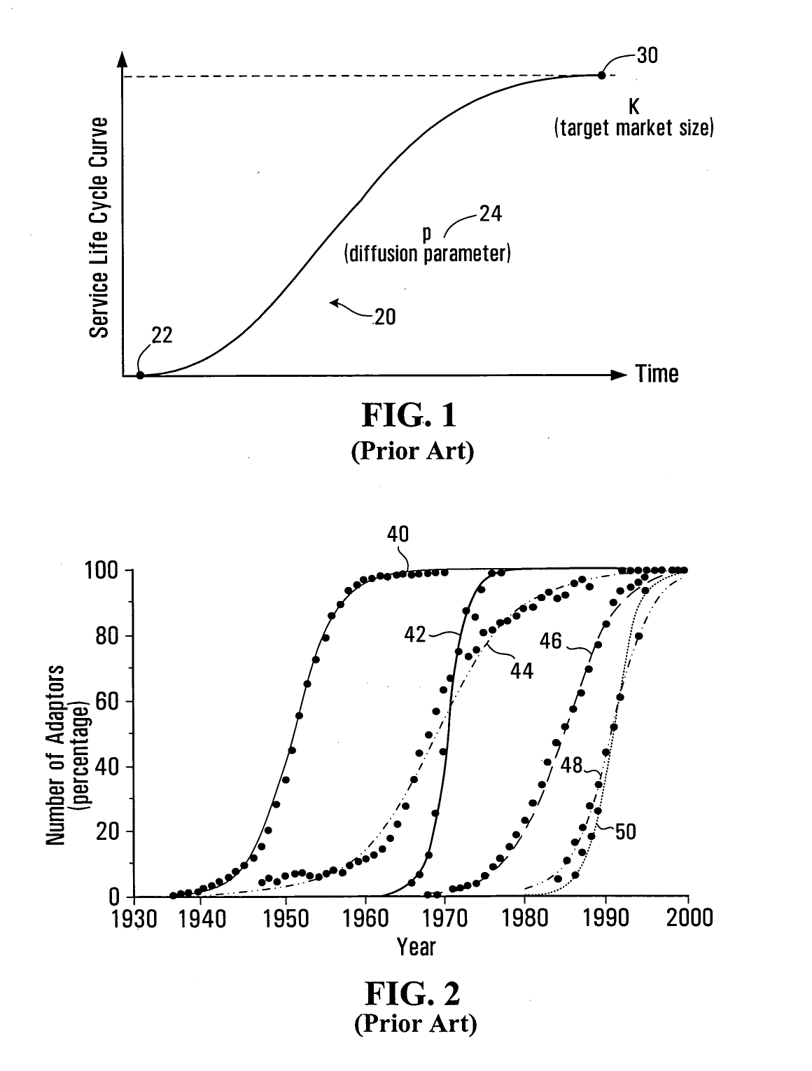

### DETAILED DESCRIPTION OF THE INVENTION

According to an embodiment of the present invention, a method and system are provided for predicting the adoption of services by subscribers over time. Generally, the invention relates to a forecasting model based on the theory of diffusion which takes into consideration influences on adoption over time.

FIG. 2 shows applications of traditional forecasting models to different technologies. It is a graph comparing an example S-curve with actual historical data of a life cycle represented by a set of points. The x-axis represents time and the y-axis represents adoption as a percentage of the maximum saturation. The graph contains a comparison 40 for diesel locomotives; a comparison 42 for front disk brakes; a comparison 44 for basic oxygen and electric steel; a comparison 46 for SPC (Stored Program Controlled) switches; comparison 48 for office personal computers; and a comparison 50 for local area networks. It can be seen that for the examples in FIG. 2, the S-curve provides a fairly realistic representation of the historical data.

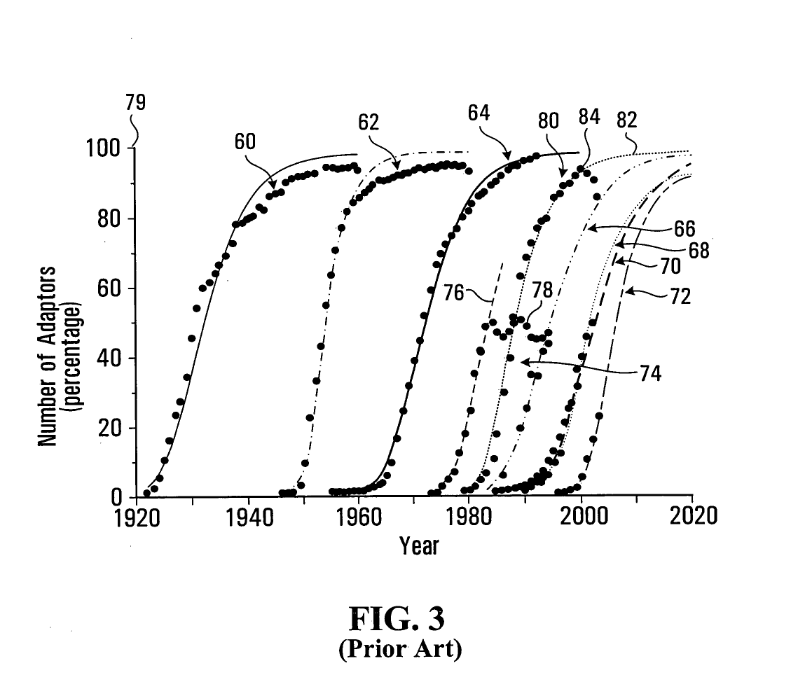

FIG. 3 shows a graph having a format that is the same as FIG. 2 but showing applications to different technologies or consumer goods. Shown is a comparison 60 for radios; a comparison 62 for televisions; a comparison 64 for color televisions; a comparison 66 for compact discs; a comparison 68 for internet connectivity; a comparison 70 for mobile phones; and a comparison 72 for broadband. For comparisons 60,62,64,66,68,70,72, it can be seen that the S-curves provide a fairly realistic representation of the actual historical data.

Also shown are curves and historical data for problematic applications of traditional forecasting models to different consumer goods or technologies. For example, a comparison 74 shows an example S-curve 76 which does not accurately model actual historical data 78 for pay cable. In particular, S-curve 76 does not model the several changes in the adoption rate of actual historical data 78, including how actual historical data 78 neither saturates nor reaches maximum saturation 79. Similarly, a comparison 80 shows an example S-curve 82 which does not accurately model actual historical data 84 for videocassette recorders. In particular, S-curve 82 approaches maximum saturation 79 while actual historical data 84 decreases in number of adopters. Unlike S-curves 76 and 82, actual historical data 78 and 84 are neither symmetrical nor cumulatively increasing in number of adopters.

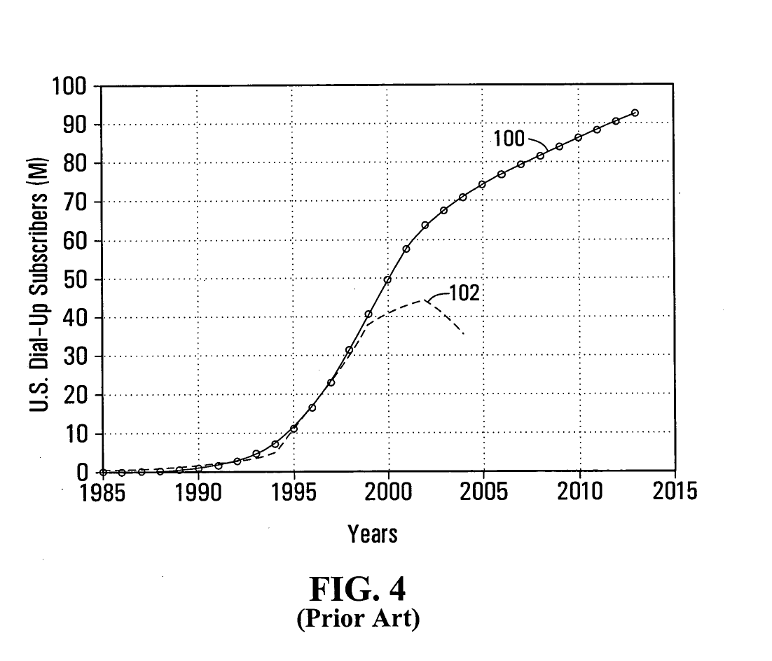

FIG. 4 shows a specific example of a problematic application of traditional forecasting models to a service. It is a graph showing an example S-curve 100 which does not accurately model actual historical data 102 for a dial-up access service. S-curve 100 shows subscription increasing and approaching saturation, while actual historical data 102 shows a peak in subscription far from maximum saturation followed by a decrease in subscription.

FIGS. 3 and 4 illustrate some of the difficulties with traditional forecasting models. For certain goods or services, the diffusion rate does not accurately reflect the rate of adoption and/or adoption does not reach maximum saturation or even saturate at all, leading to uncertainty and forecasting errors. This can be due to disruptive technologies which affect adoption by competing with the goods or services and drawing away prospective adopters. Another difficulty with traditional forecasting models is that they rely heavily on past historical data.

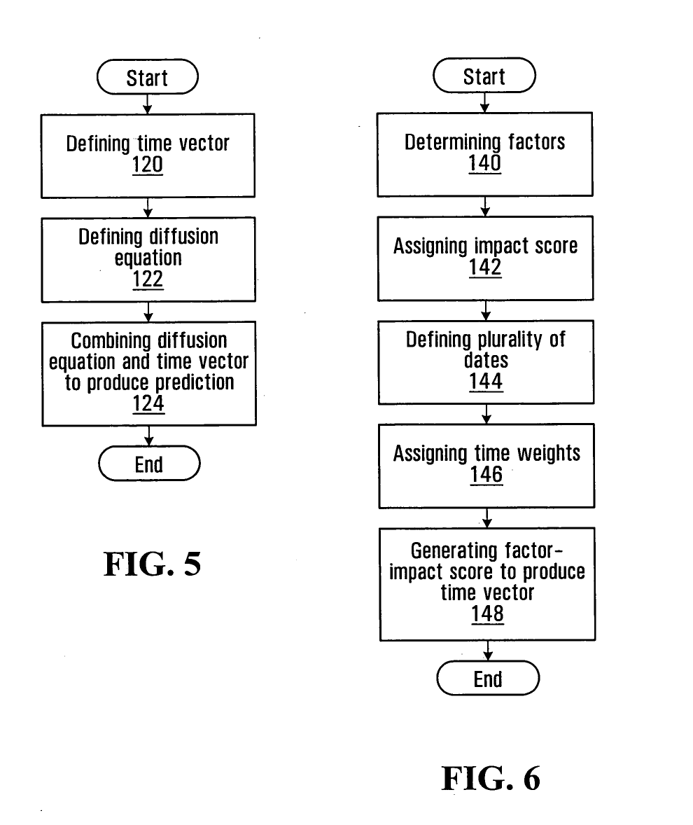

FIG. 5 is a flowchart of a method for predicting the adoption of a service by subscribers over time according to an embodiment of the present invention. At step 120, a time vector is defined for representing an influence on the adoption of a service. A time vector is a series of values, each value representing the influence at a given time. These values may be estimated or calculated. Time can be discrete or continuous. To represent different influences, a plurality of time vectors can be defined. Detailed examples of time vectors are given below.

After defining a time vector at step 120, a diffusion equation is defined at step 122. A diffusion equation expresses a relationship between the adoption of each service and a rate of change of the adoption. The rate of change can be the adoption rate or a higher derivative. Specific examples are given below. Diffusion equations other than the ones described are contemplated. At step 124, the diffusion equation is combined with the time vector to produce a prediction of the adoption. Where a plurality of time vectors is defined for representing a number of influences, the diffusion equation is combined with the plurality of time vectors. Details of how this combination can be performed are provided below.

In some embodiments, a supply model and a demand model are formulated in terms of time vectors that are then combined with the diffusion equation to produce the enhanced diffusion equation. However, not necessarily all time vectors need be generated in this way. A demand model is typically based on a potential market size. However, it can also be based on a subscriber utility vector, which is a type of time vector that is defined to represent the influence of subscriber demand on the adoption. Each value of the subscriber utility vector represents the influence of subscriber demand at a given time. A number of factors contribute to subscriber demand for a service, such as how well a service meets the needs of subscribers, how interested subscribers are in the service, and how ready they are to pay for it. For instance, a service which is too expensive reduces demand, thereby slowing down the rate of adoption or even losing subscribers.

The supply model is based on a network utility vector, which is defined to represent the influence of a provider's readiness to provide a service on the adoption. For instance, the factors that make a provider ready to provide a VoIP (Voice over Internet Protocol) service include how ready it is to deliver the quality of experience, secured content, and reliability of service expected by subscribers. A provider that manages traffic effectively and minimizes downtime will positively increase supply and thereby attract more subscribers to its VoIP service.

In some embodiments, the supply model is based on an advantage vector, which is defined to represent the influence of a provider's advantage over competing providers. For instance, such a vector can be used to capture how much of an advantage a provider offering an IPTV (Internet Protocol Television) service has over other providers depending on factors such as branding, customer service, cash flow, infrastructure, network reliability, rural area access, access to content, and value added features. One factor which gives an advantage is bundling preference. A provider which is preferred by subscribers for bundling services has an advantage over other subscribers. However, a provider which offers its service in association with video but has no expertise in video would be at a disadvantage to providers with video expertise. Lack of video expertise reduces supply and negatively influences the adoption of that provider's IPTV service.

In some embodiments, the supply model is based on a regulation vector, which is defined to represent the influence of regulations on the adoption. Regulation can be governmental or non-governmental. It includes guidelines, policies, rules, laws, and court orders. Regulation presents future risks and opportunities with introducing a service. For instance, the factors that influence the adoption of the VoIP service by way of regulation may include whether a provider must offer emergency telephone number support, whether it requires location-based services, and whether its prices are regulated. If a provider excels at some but not all of these, the regulation may slightly increase supply, thereby promoting the adoption of the service.

For example, the demand model and/or the supply model can be based on a disruption vector, which is defined to represent the influence of disruptions on the adoption. A disruption vector may be strong in influence and difficult to predict in terms of when it will occur and what will cause it. A disruption can be an event or another service which affects the advantages of providers. It can also be a combination of technology, functionality, production and adoption that disrupts some market segments and opens up new opportunities for new providers. As a result, the factors on which a disruption depends can be extensive. The introduction of a broadband access service (e.g. DSL or Cable) is an example of a service that disrupted the adoption of the dial-up access service, as subscribers left dial-up for broadband on account of the faster access. Fiber-to-the-home and wireless access could disrupt broadband access services. Regulations are often disruptive. A reduction in regulatory restrictions on IPTV would allow subscribers to have more choice in a TV service. As a result, the regulation would allow a telephone company's to offer its TV service and increase supply.

FIG. 6 is a flowchart of example steps for defining a time vector according to an embodiment of the present invention. A time vector represents an influence on an adoption of a service provided by a particular service provider. Multiple such time vectors may be generated where multiple service providers are being analyzed. Examples of the influences include the above introduced advantage, network utility, disruption, regulation and subscriber utility. At step 140, a factor that contributes to the influence is determined. For example, a factor contributing to subscriber utility is how well a service meets the needs of subscribers. At step 142 an impact score is assigned to the factor which represents the impact of the factor on the adoption. For instance, a factor such as the cost of a service could be assigned a high impact score on account of the significant impact it has on demand. The impact score can be estimated or calculated. At step 144 a plurality of dates is defined. These are the dates that will be represented in the time vector. Note that while the embodiments described assume discrete time vectors, some influences may be represented as continuous functions of time. At step 146 a time weight is assigned to the factor and the provider of the service at each date. The time weights represent a weighting of the factor for its importance for the provider over time. It can be estimated or calculated. At step 148 a factor-impact score is generated for the factor and the provider at each date to produce the time vector. Each factor-impact score represents a weighting of one of the time weights against the impact score. Finally, the time vector is formed as a series of vector-impact scores over the plurality of dates.

In some embodiments, where a number of factors contribute to the influence, steps 140 to 142 and 146 to 148 can be repeated for each factor. Furthermore, each impact score assigned to a factor not only represents the factor's impact, but also serves to differentiate the factor from factors having a different impact. In a further step, the factor-impact scores of the number of factors are summed by date so that each date has a total score. The time vector is formed as a series of all total scores.

In some embodiments, where a number of providers offer a service, steps 146 to 148 can be repeated for each provider. Furthermore, each time weight assigned to a factor and a provider not only represents the varying effect of a factor over time, but also differentiates the provider from other providers having a different time weights. The time vector of each provider is formed as a series of all factor-impact scores for the provider.

In yet another embodiment, defining the time vector further comprises generating a normalized score for the provider at each date. The normalized score represents the strength-impact score normalized over the plurality of dates.

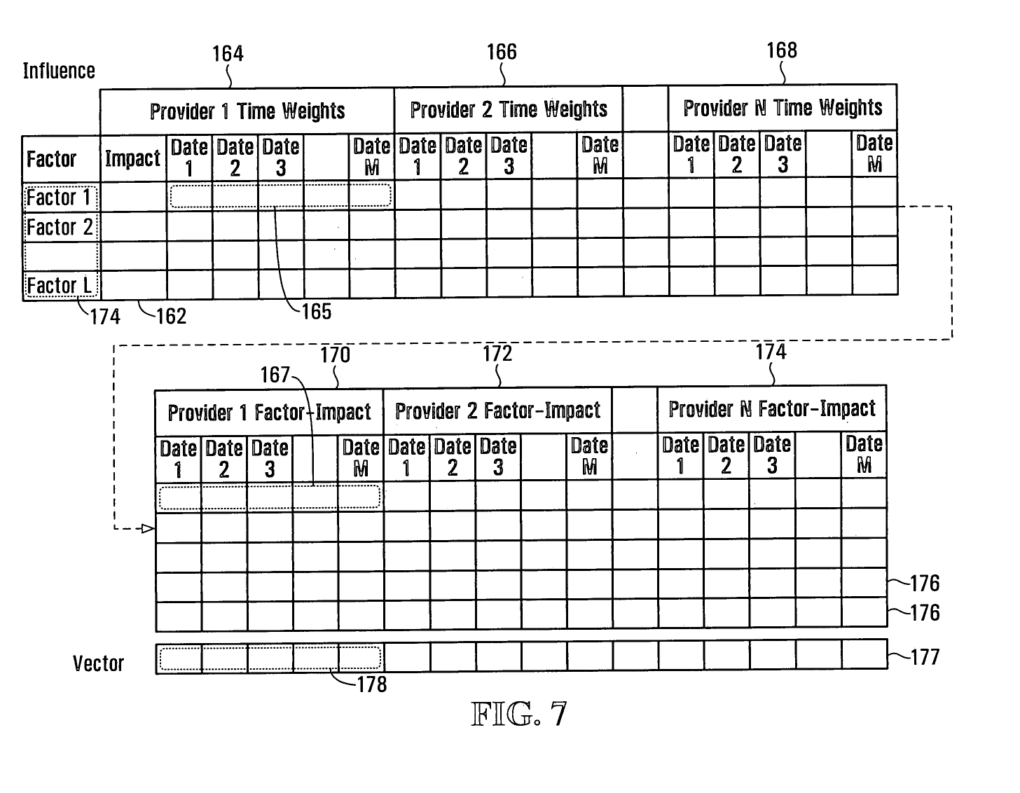

FIG. 7 shows a table of example variables implementing the steps in FIG. 6 for defining a time vector according to an embodiment of the present invention for a particular influence, and for multiple service providers. A set of factors for the influence is listed at 174. For each factor, an impact score 162 is assigned. For example, impact score 162 might range from one to three, where three has the strongest impact. Defined is a plurality of dates. For example, there could be five dates covering fifteen years. The dates are labeled as Date 1, Date 2, . . . , Date M, and the table includes a set of time weights for each date and for each provider. The time weights (one set for each factor) for providers 1, 2 and N are indicated at 164,166,168 respectively. A particular set of time weights for “Factor 1”, and “Provider 1” is indicated at 165. The time weights include a time weight assigned to each factor 174 for a given provider at each date of the plurality of dates. For example, time weights might have a value from zero to five, where zero represents no contribution and five represents maximum contribution.

A factor-impact score is generated for each factor 174 and each provider at each date. Factor impact scores (one set for each factor) for providers 1, 2 and N are indicated at 170,172,176 respectively. A particular set of factor impact scores for factor 1 and provider 1 is indicated at 167. For example, each factor-impact score can be a product of a time weight and an impact score. The factor-impact scores of the factors 174 are summed by date for each provider. These sums are indicated as total scores 176. Finally, the total scores are normalized to generate normalized scores 177. A time vector is formed as a series of normalized scores at each date 170 for a given service provider. A particular vector is indicated at 178.

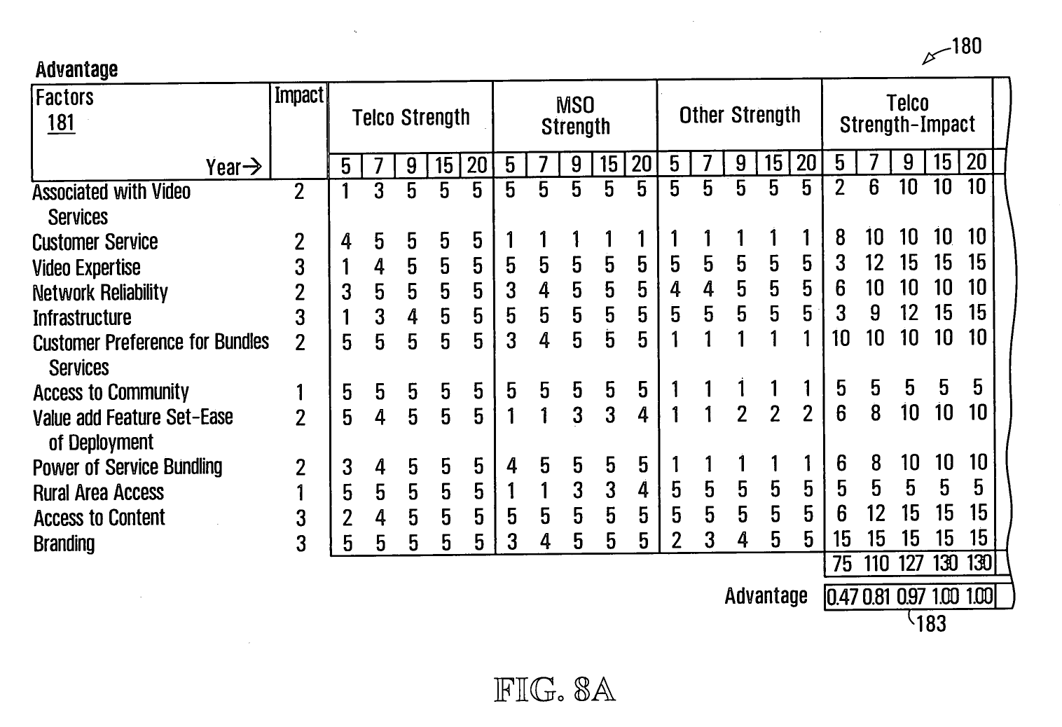

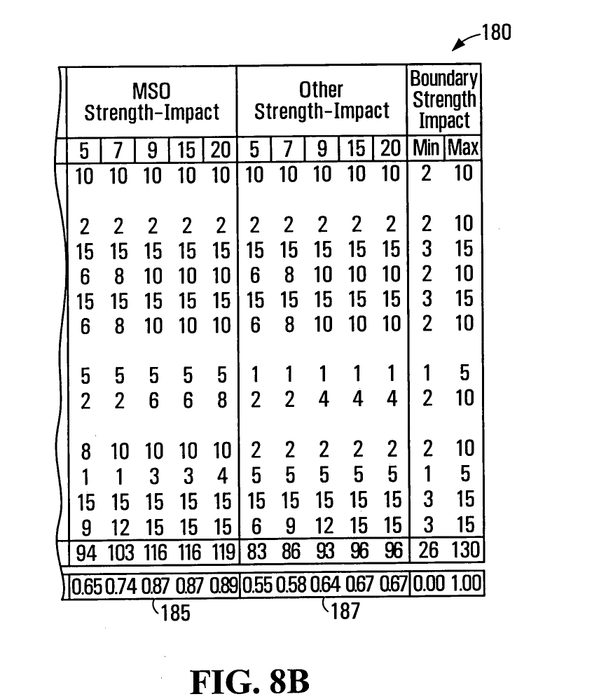

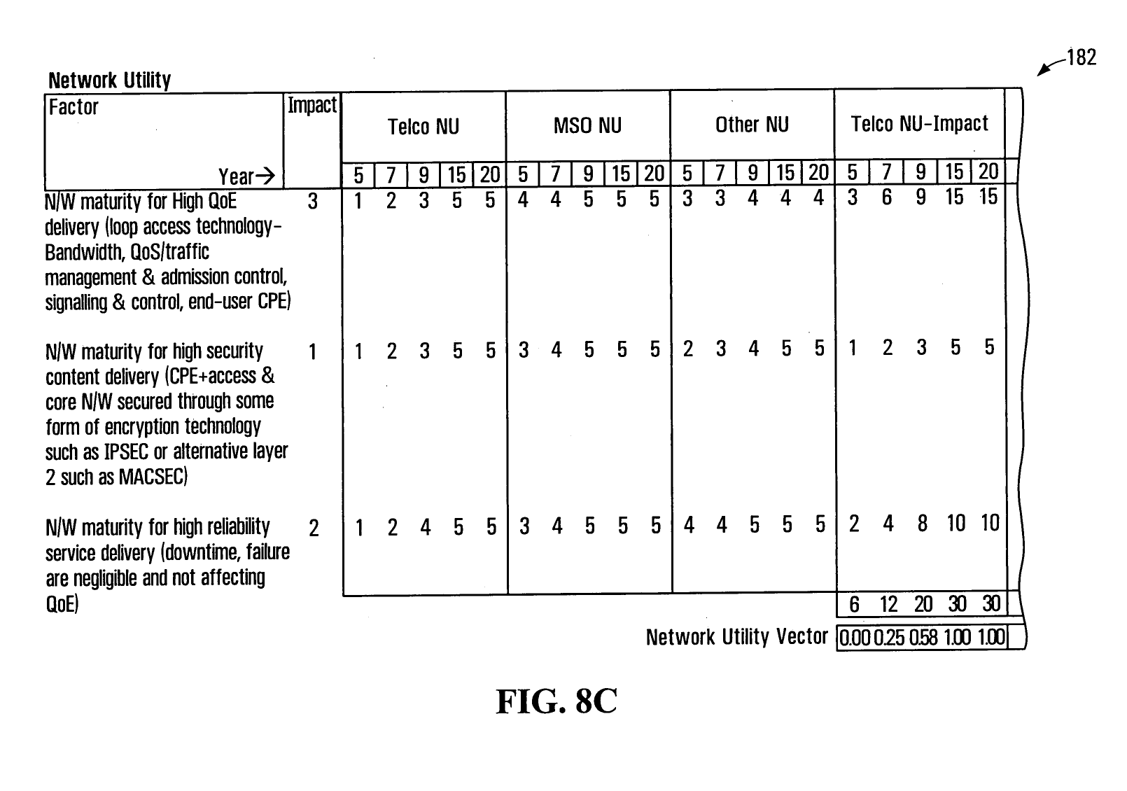

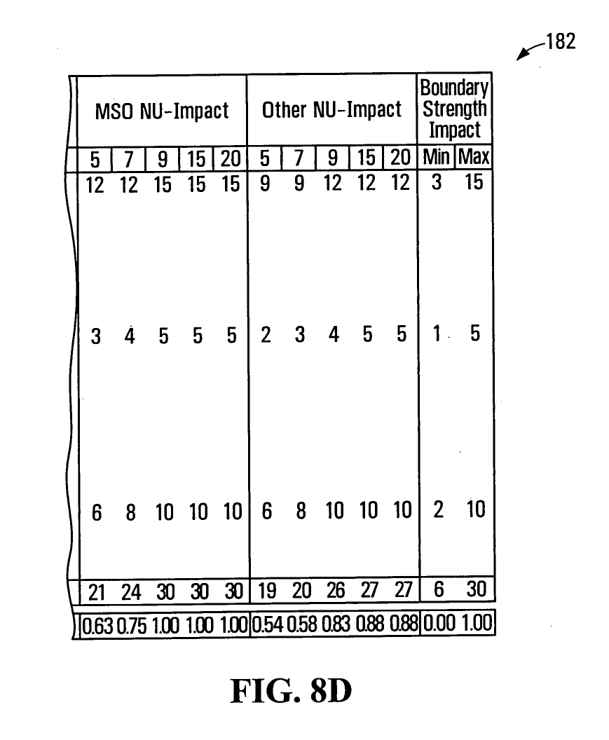

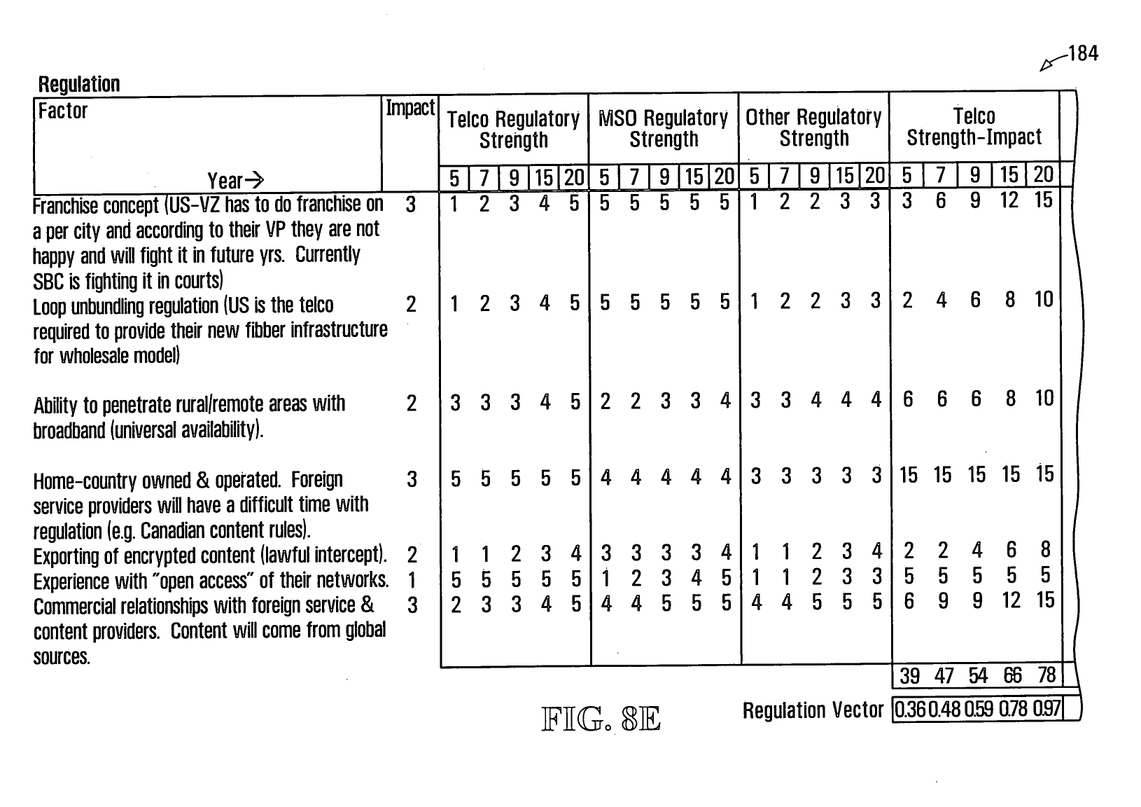

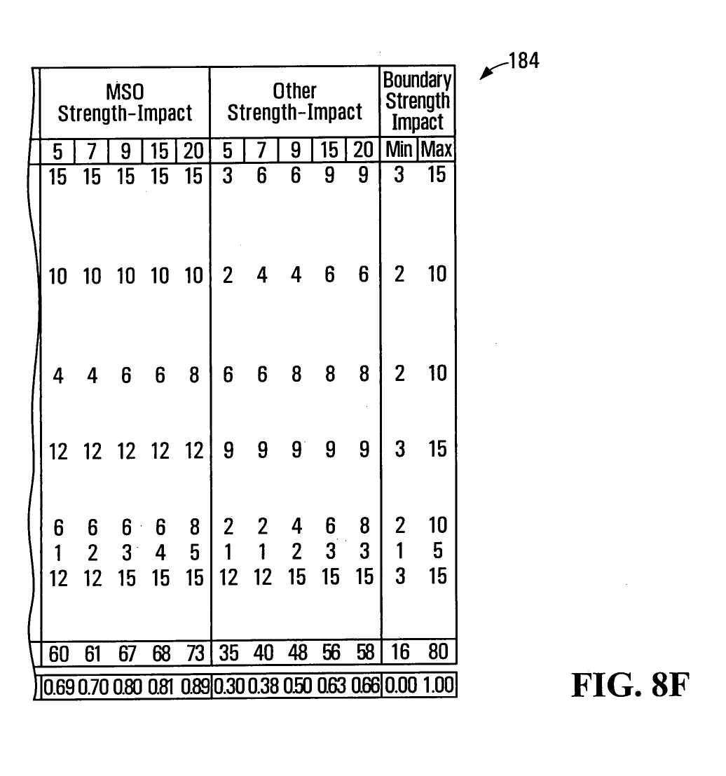

FIGS. 8A to 8F shows table having a format that is the same as FIG. 7 featuring example values for defining time vectors for the IPTV service according to an embodiment of the present invention. FIGS. 8A and 8B show a first table 180 for defining an advantage vector (for the advantage influence) for each of three service providers. FIGS. 8C and 8D show a second table 182 for defining a network utility vector (for the network utility influence) for each of three service providers. FIGS. 8E and 8F show a third table 184 for defining a regulation vector (for the regulation influence) for each of three service providers.

For the table 180 defining the advantage vector, the factors 181 include associated with video services, customer service, video expertise, network reliability, infrastructure, customer preference for bundled services, access to community, value add feature set—ease of deployment, power of service bundling, rural area access, access to content and branding. An advantage vector is formed as a series of five values spanning five time periods covering 15 years. Each time period has its own time weight for each factor, referred to as “strengths” for the advantage vector example. The time weights and the impact are combined for the multiple factors as described above to produce the advantage vectors 183,185,187 for the three service providers. The values range from zero to one, where zero represents no influence due and one means maximum influence due to an advantage. The minimum and the maximum strengths are also indicated. This can be used in the normalization calculation. For example, advantage vector 183 consists of the series of values (0.47, 0.61, 0.97, 1.00, 1.00). The values show that for the particular provider, the advantage over other providers has an increasing effect over time upon service adoption for that provider. The values start with a value of 0.47 in year 2005 and end with a value of 1.00 in years 2016 to 2020. Table 182,184 are similar and will not be described in further detail.

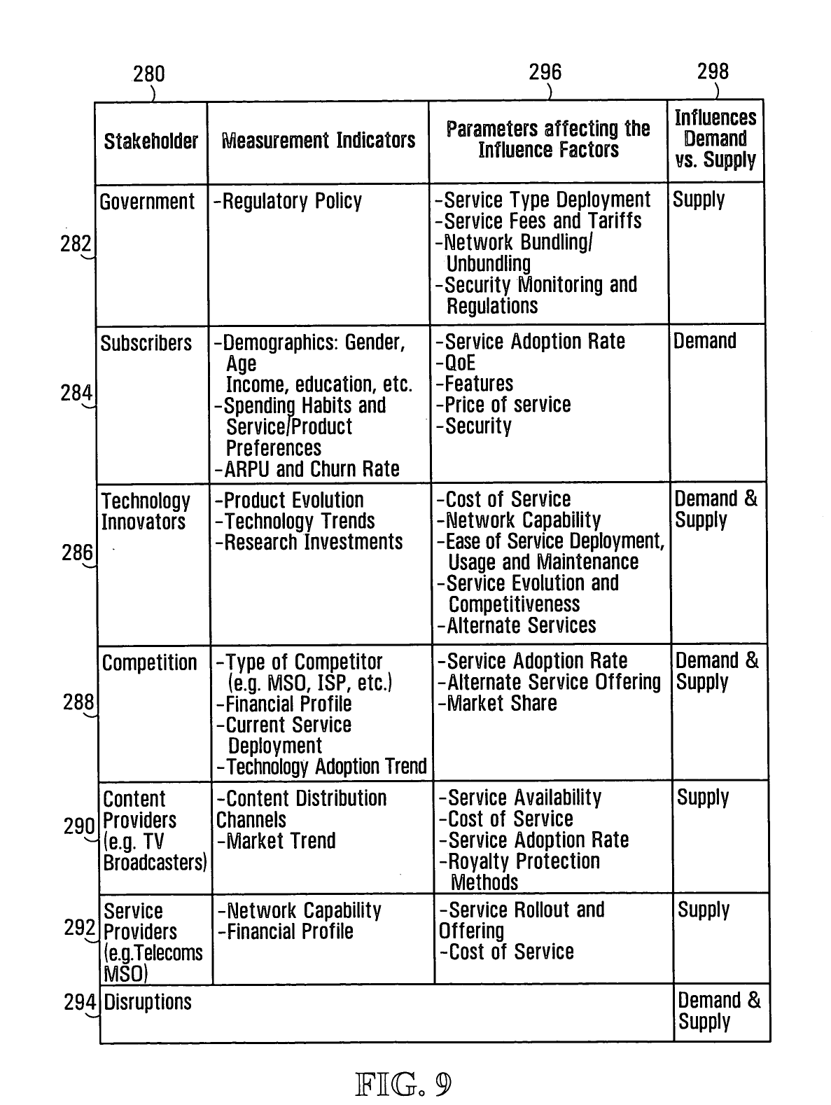

In another embodiment, defining the time vector further comprises estimating a provider's strength score based on the influence of a stakeholder. A stakeholder has an influence on the adoption of a service. For example, a government can restrict the bundling of a service by way of regulations. This factor influences supply. As such, it can be included in a time vector determined from the supply model, such as a disruption vector. In defining the time vector, if the government places such restrictions, then a provider could be assigned a low strength score in respect of bundling. FIG. 9 is a table of example stakeholders that influence demand and/or supply for a service. A stakeholder 280 can be, for example, a government 282 which regulates offerings of the service, allows the service to be deployed, or restricts the service from being deployed; or a subscriber 284, who will not adopt if they are not interested on account of price or quality. Stakeholder 280 can also be an innovator 286, a competitor 288, a content provider 290, a service provider 292, or a disruption 294. Each stakeholder 280 has factors 296 that influence a supply and/or demand model 298.

It is noted that the factors forming a given time vector are not necessarily fixed and can be expanded depending on the type of service to be modeled. Factors can be added or deleted as needed, a goal being to identify the ones most relevant for a particular market

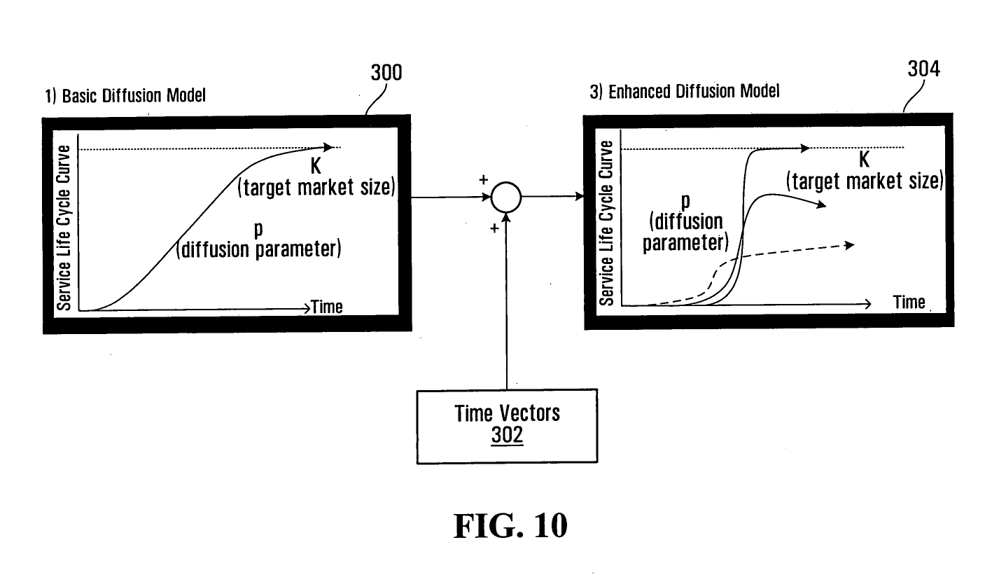

FIG. 10 is a conceptual block diagram illustrating combining a basic diffusion model 300 and time vectors 302 to produce an enhanced diffusion model 304. The combination taking place in FIG. 9 can be implemented in any number of ways. Specific examples are given below.

In some embodiments, the combination involves taking one or more parameters of the diffusion equation that are fixed in conventional diffusion equations (e.g. previously introduced p and K) and making each parameter a function of the time using one or more of the time vectors 302.

Thus, where a normal diffusion equation would be expressed as a function of parameters p; and time t as f(p₁, . . . , pₖ, pₖ₊₁, p_{N}, t), the new equation is expressed as f(p₁(timevector₁₁, timevector₁₂, . . . , timevector_{1M}_{₁}, t) . . . pₖ(timevectorₖ₁, timevectorₖ₂, . . . , timevector_{kM}_{ₖ}), pₖ₊₁, p_{N}, t) where there are N parameters of which k are expressed as a function of time vectors, with the ith parameter being a function of Mᵢ timevectorᵢ₁, . . . , timevector_{iM}_{ᵢ}.

In a particular implementation, the saturation parameter K and the diffusion parameter p are each made a function of time using one or more time vectors.

Different diffusion processes have different parameters. The BASS model uses p, q and K, whereas the Gompertz model uses p and K, and q=0. There are published models where K is made dynamic, but not a function of time (e.g., K=f(price or advertising).

In some embodiments, the saturation parameter K is made a function of the advantage vector and the subscriber utility vector. It can also be a function of other data, such as the potential market size and demographic data parameter. As a specific example, the total addressable market size can be multiplied by the output of the vectors chosen. If the total market size is 100, and the output vector is (0.25, 0.5, 1.) then multiplying 100*(0.25,0.5,1) produces (25,50,100) as the addressable market for that period of time. This function could be expressed differently though.

In some embodiments, the K parameter is also a function of the disruption vector, as long as the underlying diffusion process is properly modeled.

In some embodiments, the diffusion parameter p is made a function of the subscriber utility vector, network utility vector, advantage vector and regulation vector. In some embodiments, p parameter is also a function of the disruption vector, as long as the underlying diffusion process is properly modeled.

Where the service is deployed by different providers, the saturation parameter K and diffusion parameter p are obtained for each provider.

The enhanced diffusion model can have an asymmetrical curve and have an end-point that might not saturate due to the impact of factors. If the model requires tuning, one of the ways that it can be tuned is by adjusting the impact score or the factor score for one or more factors of one or more influences.

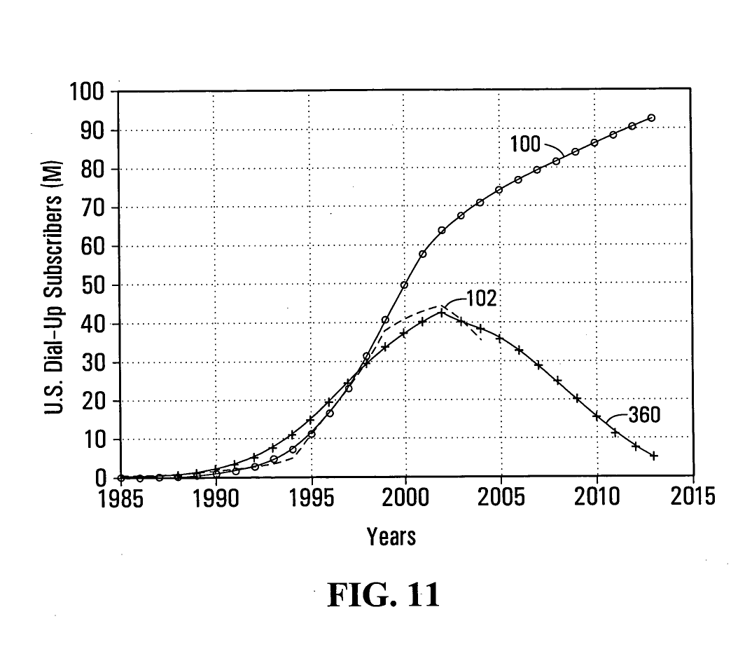

FIG. 11 is a graph showing actual historical data 102 for the dial-up access service modeled by a conventional S-curve 100 and an example enhanced model 360. The y-axis represents the number of subscribers to the dial-up access service in the millions and the x-axis represents time. Unlike S-curve 100, enhanced model 360 takes into consideration the disruption caused by the adoption of the broadband access service using technologies such as digital subscriber line and cable. In particular, subscribers to the dial-up access service migrated to the broadband access service and were joined by new subscribers.

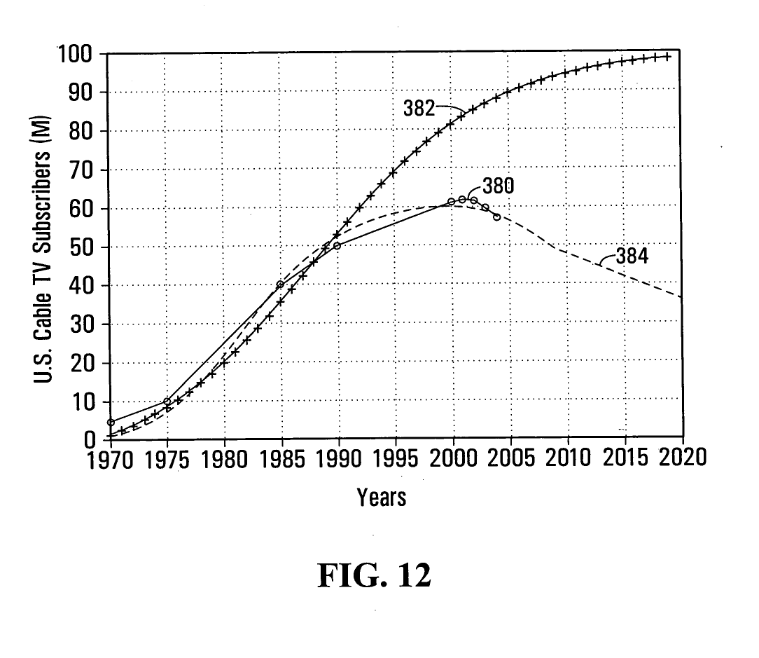

FIG. 12 is a graph showing actual historical data 380 for a cable TV service modeled by an example S-curve 382 and an example enhanced model 384. Enhanced model 384 takes into consideration the disruption caused by a satellite TV service and possibly by a telephone company IPTV service.

In some embodiments, the method further comprises using the enhanced model to prioritize business investment decisions, validate a customer business case, validate a product feature requirement, validate a network solution to ensure adequacy of quality of experience delivery, increase credibility in making business decisions, identify emerging services, identify the adoption rate, identify deployment timeline, identify the service having the fastest adoption rate, identify the factors having the most influence on the adoption rate, determine the impact of emerging services, build a cost model, project profits, estimate the phases of a life cycle to measure the time windows for return on investment, or predict when a category of adopters known as the late majority occurs. The accuracy of the prediction can be tested against past historical data.

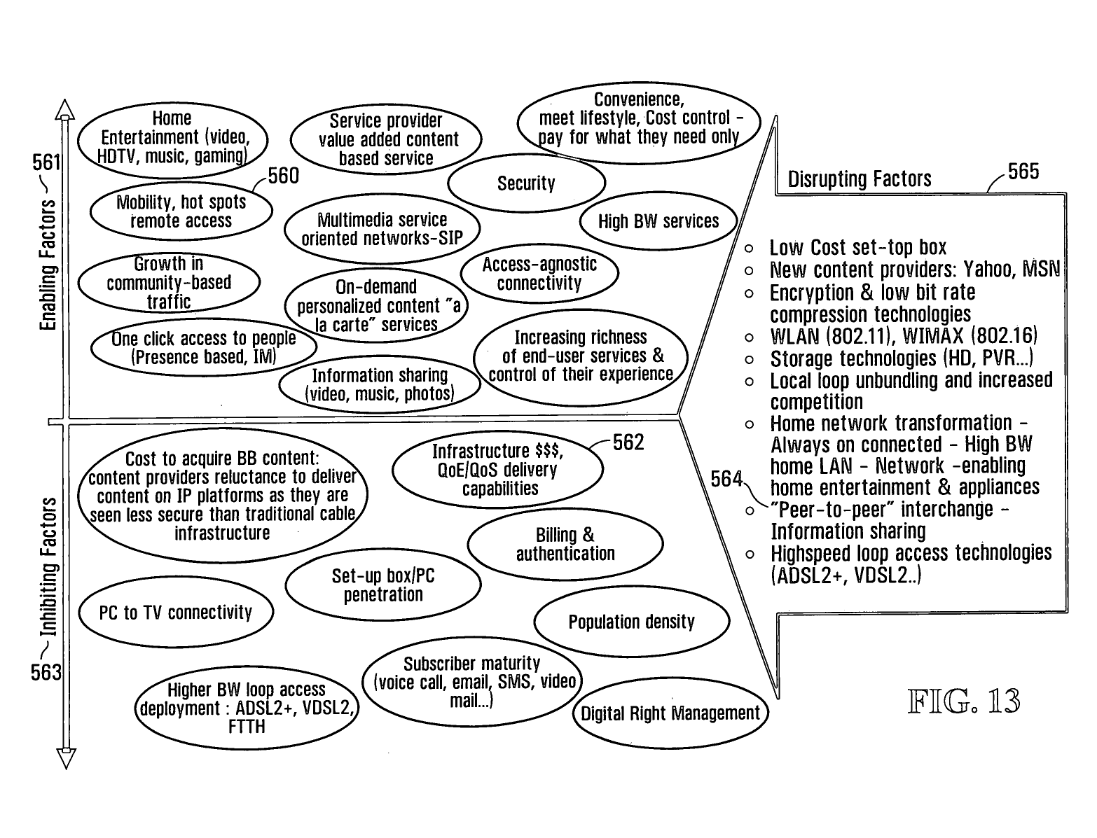

In another embodiment, the method further comprises selecting a service from a class of services based on factors that enable, inhibit or disrupt the adoption of a class of services. FIG. 13 is a diagram of example factors for broadband access services including enabling factors 561, inhibiting factors 563 and disrupting factors 565. An example of an enabling factor is mobility 560 which makes broadband access more attractive to prospective subscribers. An example of an inhibiting factor is infrastructure cost 562 as this can be prohibitive to subscribers. An example of a disrupting factor is peer-to-peer information sharing 564 which may or may not render providers or subscribers liable for illegal sharing, improve services, or minimize costs. As a result, adoption could increase, decrease or remain unchanged. Based on these factors, a service such as VoIP could be selected, as it allows telephone calls to be forwarded to a desired telephone number, it is inexpensive, and a certain peer-to-peer VoIP services are rapidly making prospective subscribers aware of VoIP.

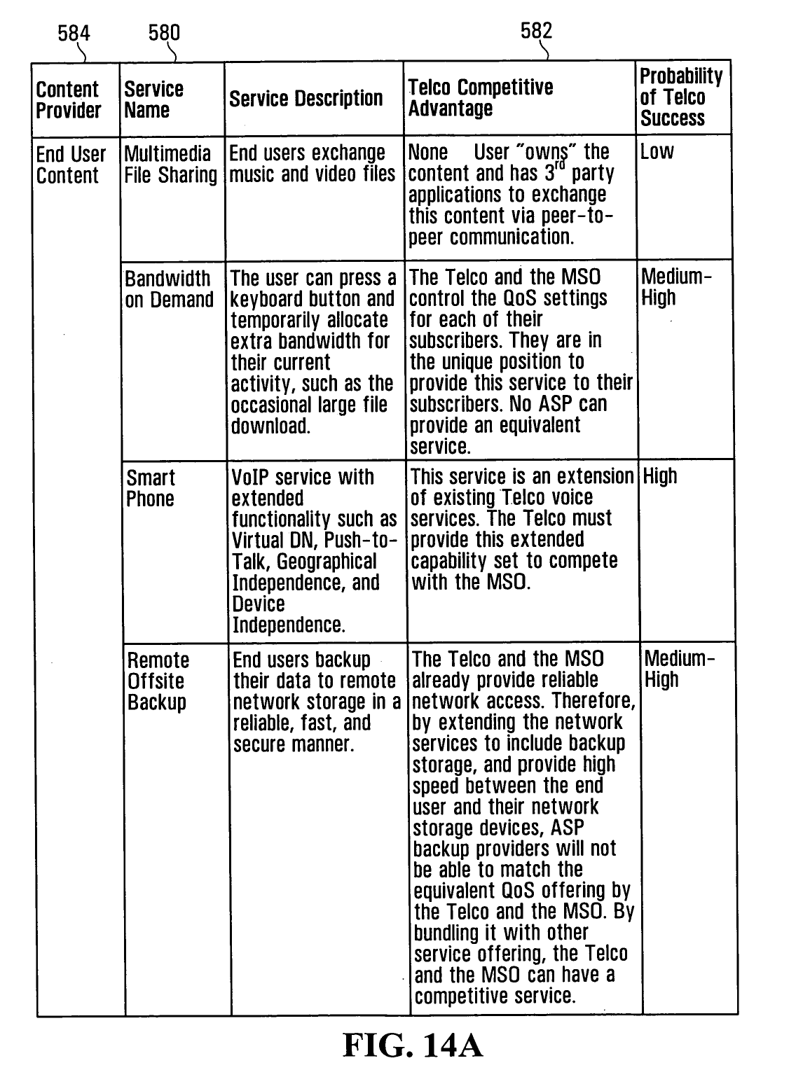

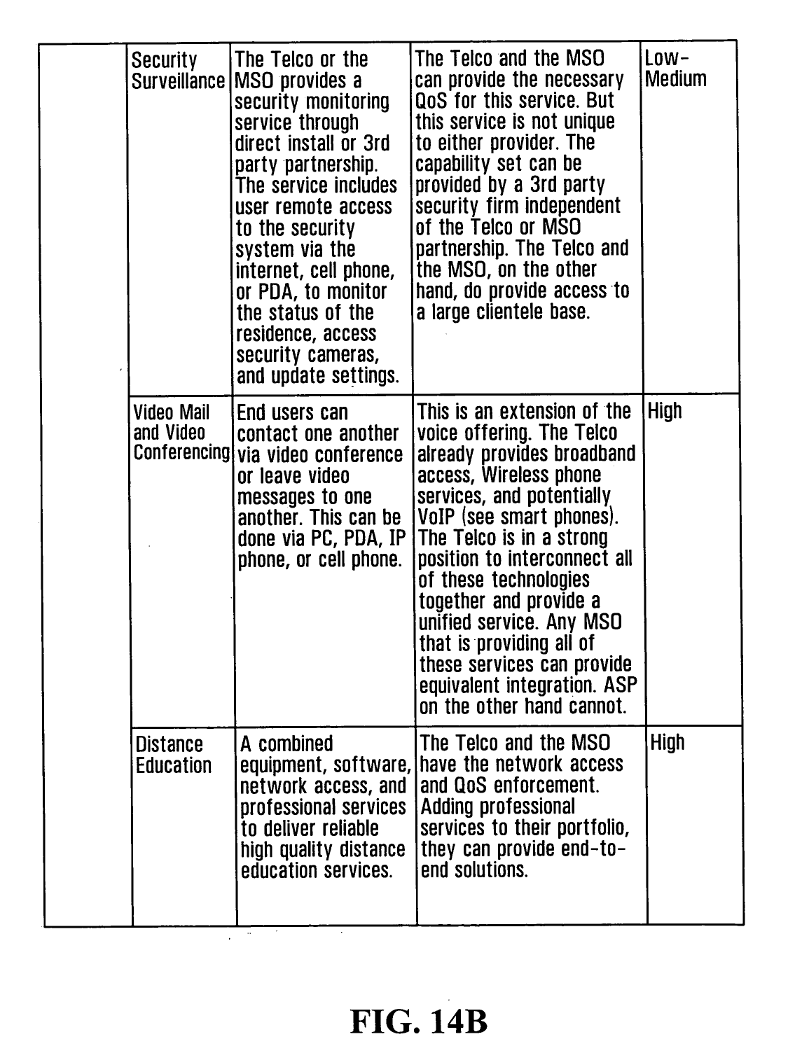

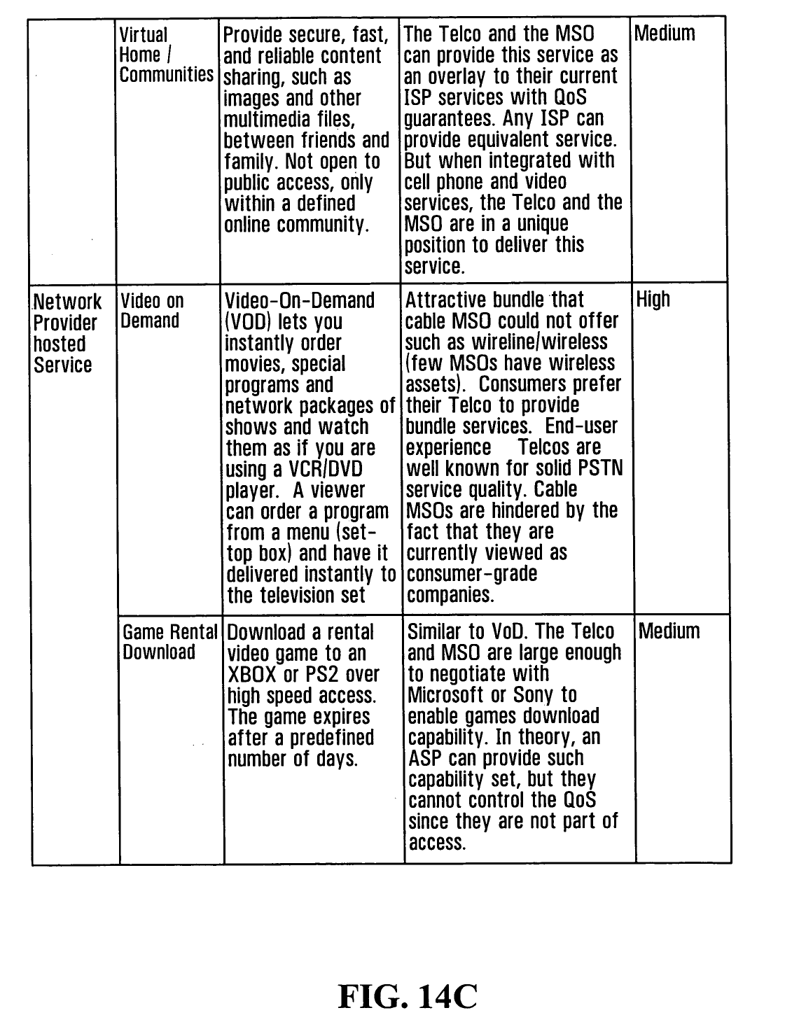

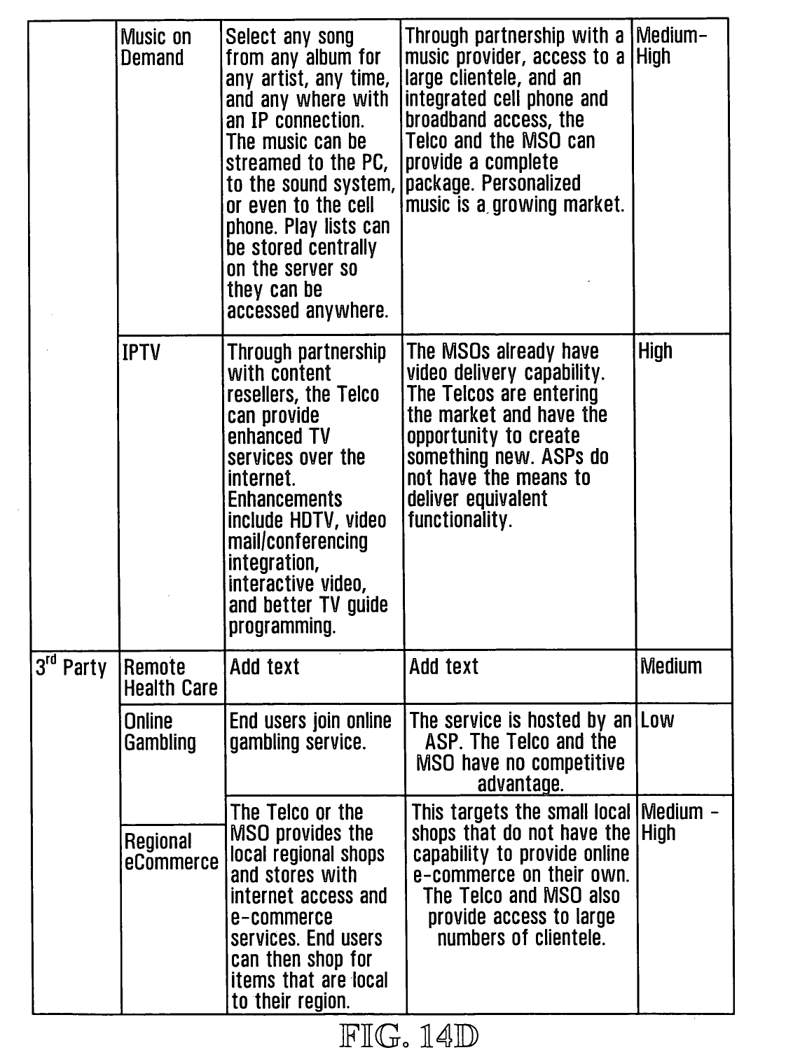

In another embodiment, the method further comprises selecting a service based on a provider over another provider on account of the type of content of the service. For example, a video on demand service, which lets subscribers order and view movies via broadband, involves network provider hosted content, which originates with the network provider. A network provider such as a telephone company can have an advantage on account of such content if it is difficult for the competition to produce the content. The telephone company's ability to bundle video on demand with other services and to offer an extended library of movies gives it an advantage, making video on demand a good choice of service for a telephone company. FIGS. 14A to 14D contain a table of example broadband access services 580, and for each service an advantage 582 of a telephone company on account of a type of content 584.

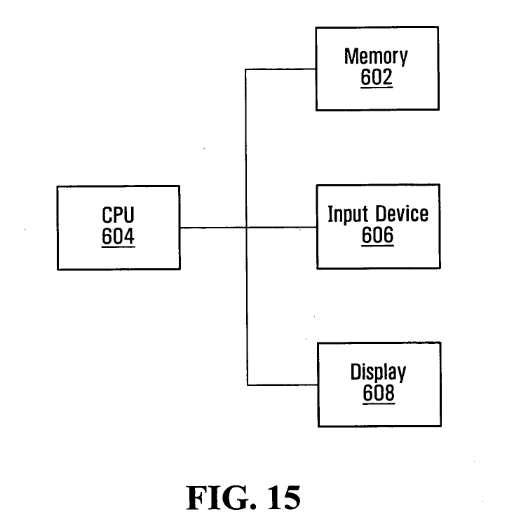

In some embodiments, defining the time vector further comprises estimating a provider's strength score in respect of a factor based on business considerations, such as target market, quality of experience, required technology, network requirements, strengths, weaknesses, opportunities, and threats. For example, a telephone provider which offers the IPTV service, and has the opportunity to bundle it with a broadband access service and a voice service, can be assigned a high strength score. FIG. 14 is a table of example generic business considerations. FIG. 15 is a table of example business considerations for the IPTV service. FIG. 12 is a table of example business considerations for the VoIP service.

FIG. 15 is a block diagram of a system 600 for predicting the adoption of a service by subscribers over time provided by an embodiment of the invention. System 600 may consist of a personal computer, a workstation, a large computer, a mobile computer, an electronic diary, or the like. It is provided with a memory 602, a CPU (Central Processing Unit) 604, an input device 606 and a display 608 coupled together by a bus.

Memory 602 can be a random access memory device; or a read-only memory device, such as a hard disc device, an IC (Integrated Circuit) memory, a magnetic disc device, an optical disc device; or other memory. Memory 602 contains instructions for defining a time vector, defining a diffusion equation, and combining the diffusion equation and the time vector to produce a prediction of the adoption.

CPU 604 is configured to access information from and provide information to memory 602, as well as execute instructions.

Input device 606 can be a keyboard, a mouse, a track ball, an input pen, an input tablet, a disk drive or other input device for providing information to system 600.

Display 608 can be a CRT (Cathode Ray Tube) display device, a LCD (Liquid Crystal Display) device or other display for displaying information.

In addition, although described primarily in the context of a method for predicting the adoption of services, other implementations of the invention are also contemplated.

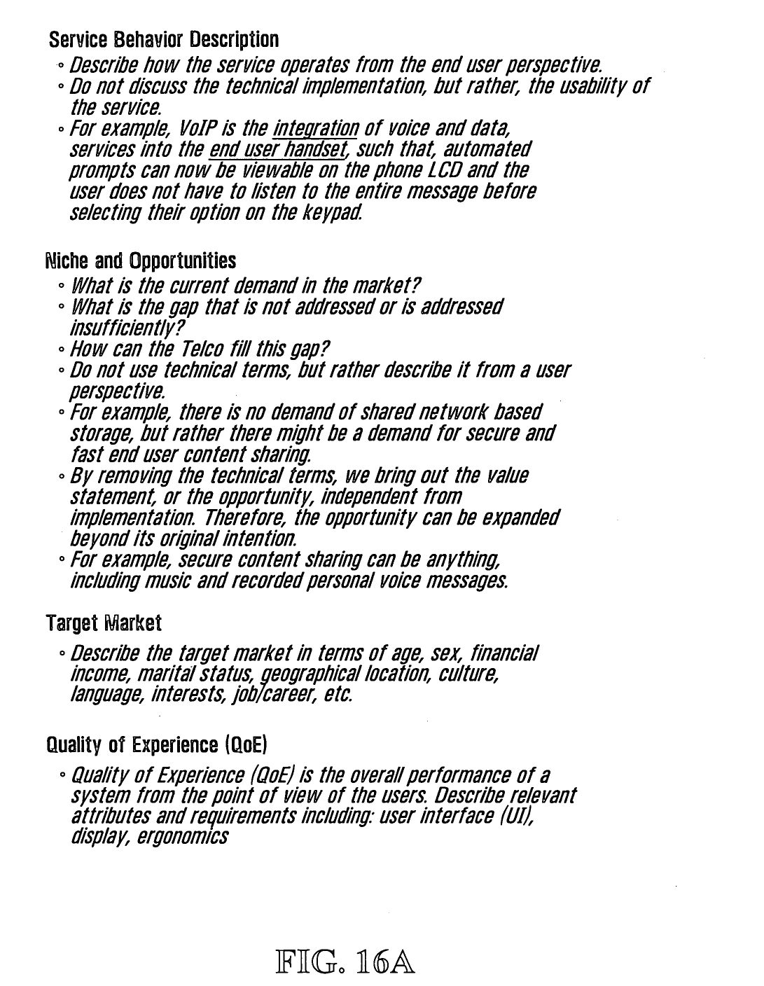

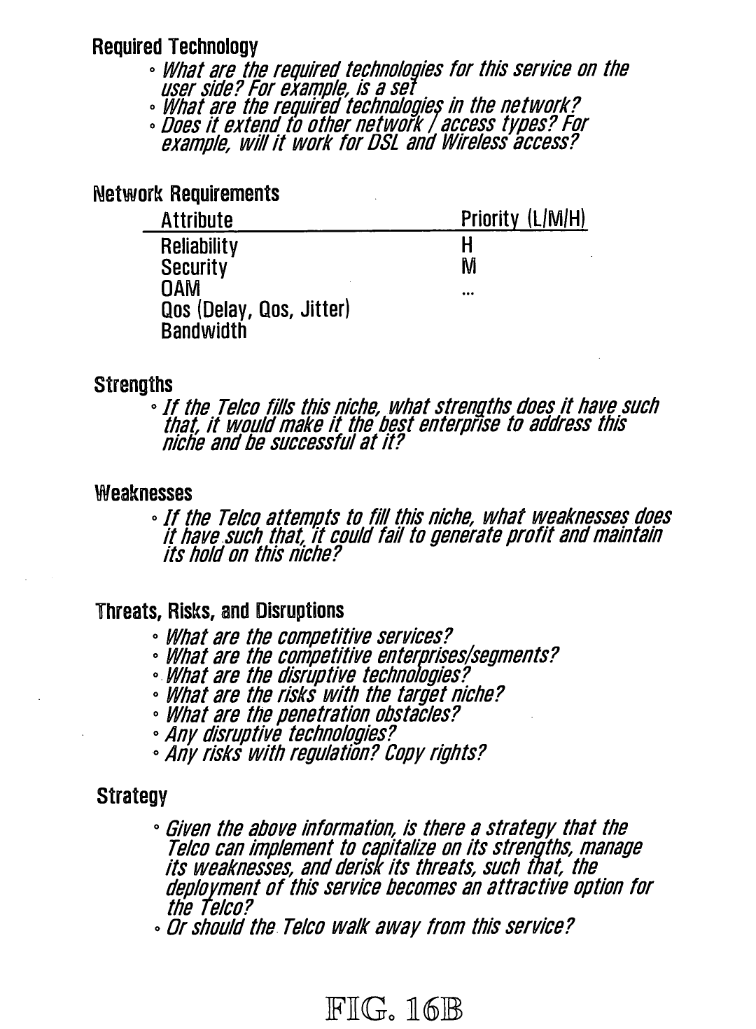

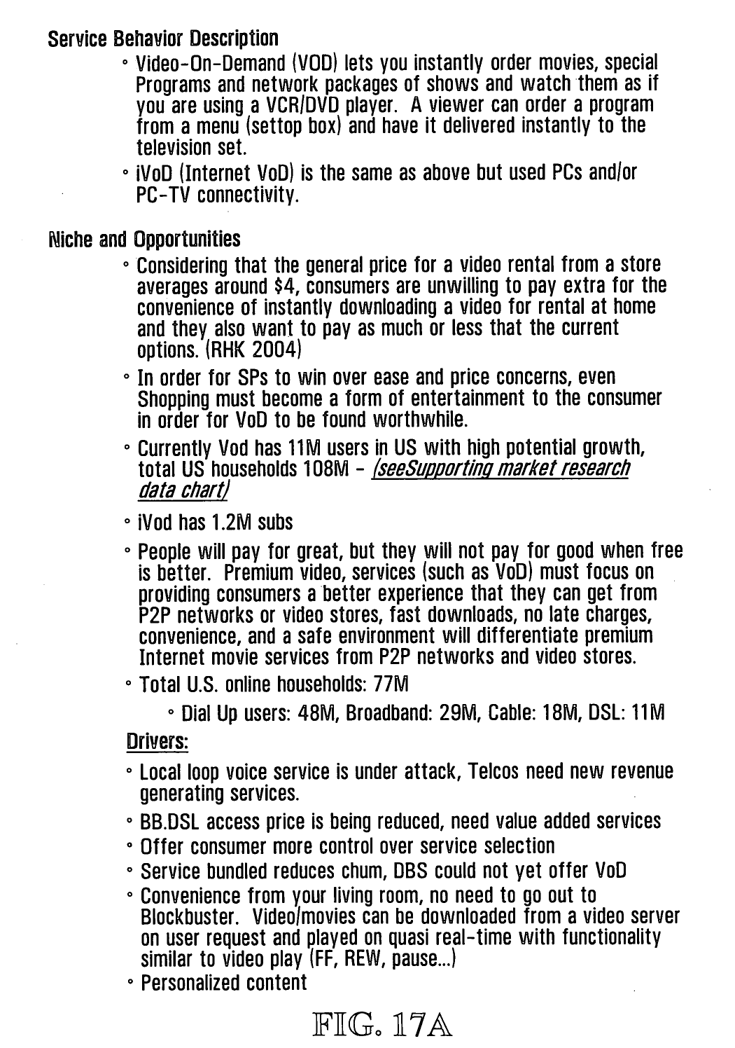

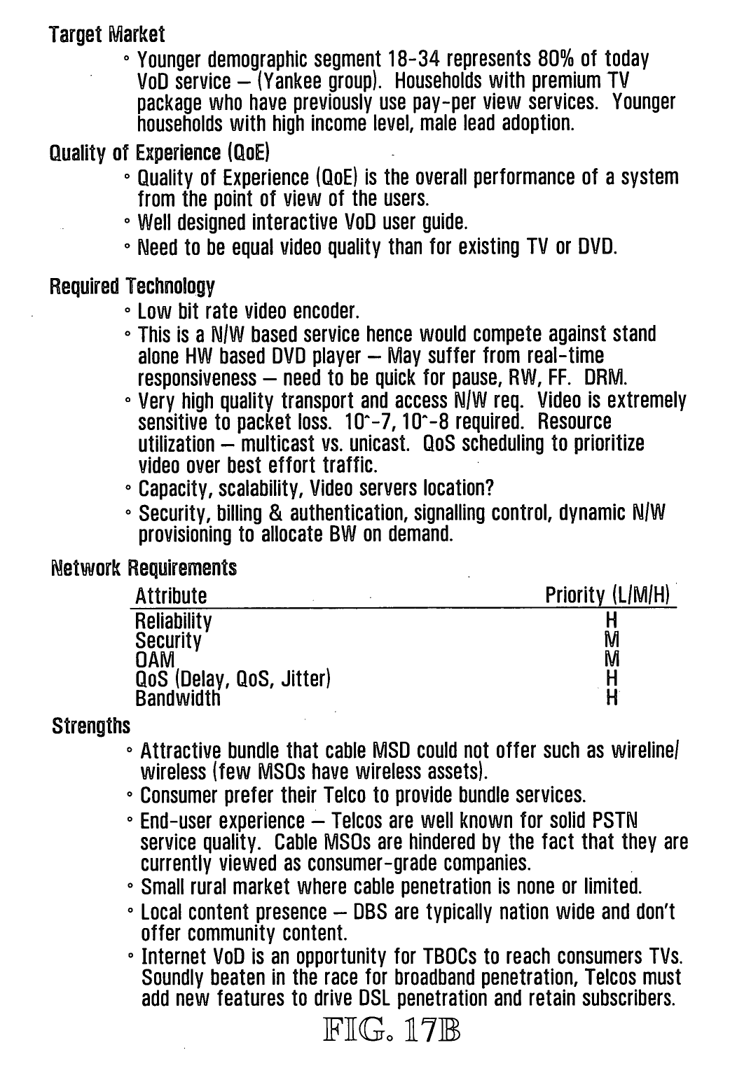

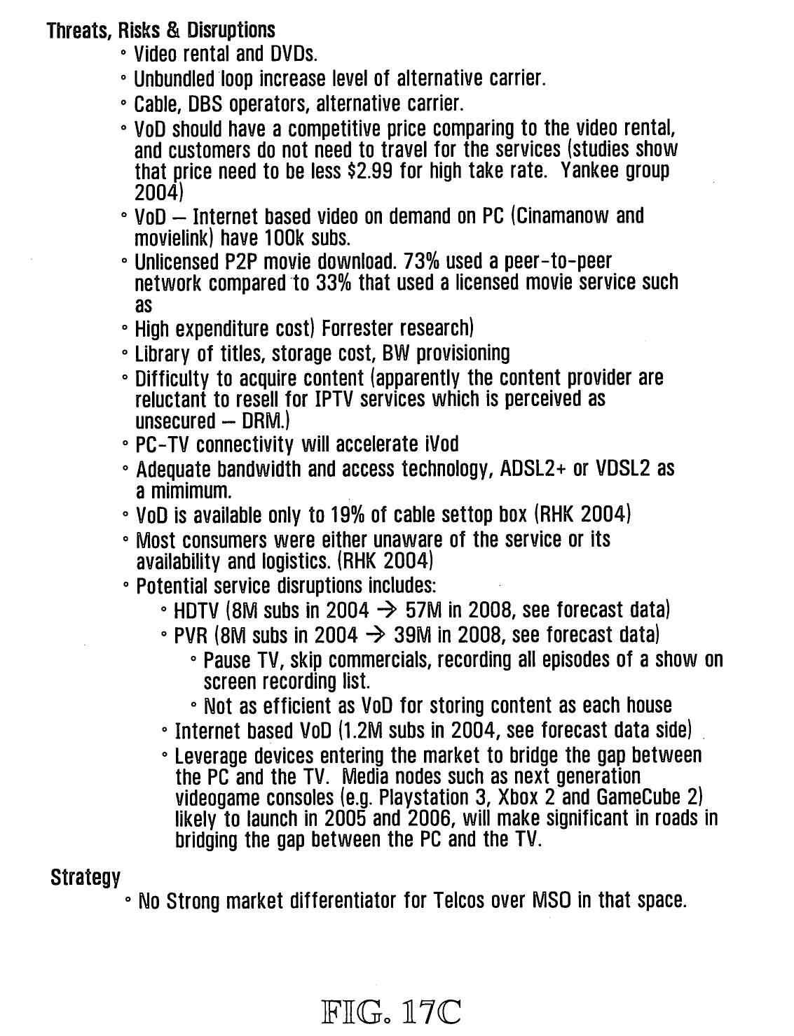

FIGS. 16A and 16B show a generic service template, and FIGS. 17A, 17B and 17C show a specific example for VoD.

The purpose of the service template is to facilitate the creation of the time vector. This is where key influence factors can be documented that will be considered in the creation of the time vectors weights, impact, etc.

The template describes and analyzes the niche and opportunities, target market, a SWOT analysis and a number of key factors that will influence the adoption rate such as Quality of Experience (QoE), required technology, network requirements, etc. The template provides a format for listing a qualitative representation of the service. The time vector is a quantitative representation of the service. These service templates serve as the basis to the construction of the analytical model and the vectors that will be used to forecast the adoption rate.

Other diffusion equations than the ones described are contemplated. For descriptions of such equations the references cited herein are expressly incorporated by reference and relied upon.
Fisher-Pry model, Fisher, J C, Pry, R H. A Simple Substitution Model of Technological Change. Technology Forecasting and Social Change, 3, 75-88, 1971.
E. M. Rogers, T. W. Valente, “The origins and development of the diffusion of innovation paradigm as an example of scientific growth”, Science Communication, 16, pp. 242-273, 1995.
F. M. Bass, “A New Product Growth for Model Consumer Durables”, Management Science, Vol. 15, No. 5, January 1969.
V. Mahajan, E. Muller, “Innovation Diffusion and New Product Growth Models in Marketing”, Journal of Marketing, Vol. 43, pp. 55-68, Fall 1979.
V. Mahajan, Y. Wind, Innovation Diffusion Models of new Product Acceptance, Vol 5 of Series on Econometrics and Management Sciences, Ballinger Publishing Company, Cambridge, Mass., 1986.

What has been described is merely illustrative of the application of the principles of the invention. Other arrangements and methods can be implemented by those skilled in the art without departing from the spirit and scope of the present invention.

1. A method for predicting an adoption of a service by subscribers over time, the method comprising the steps of:
for each of at least one influence on the adoption defining at least one time vector that represents the influence;
defining a diffusion equation that expresses a relationship between the adoption and a rate of change of the adoption; and
combining the diffusion equation and the at least one time vector for each influence to produce an enhanced diffusion model.

2. The method according to claim 1, wherein at least one time vector is determined from a demand model, a supply model, or the supply model and the demand model.

3. The method according to claim 1, wherein the at least one time vector includes at least one of a subscriber utility vector that represents the influence of subscriber demand on the adoption, a network utility vector that represents the influence of a provider's readiness to provide a service, an advantage vector that represents the influence of an advantage of the provider over another provider, a regulation vector that represents the influence of a regulation, and a disruption vector that represents the influence of a disruption.

4. The method according to claim 1, wherein the diffusion equation is selected from a group consisting of the Bass, Gompertz, and FisherPry diffusion equations.

5. The method according to claim 1, wherein defining the at least one time vector comprises:
determining at least one factor that contributes to the influence;
assigning to the at least one factor an impact score that represents the impact of the at least one factor on the adoption;
defining a plurality of dates;
assigning to a provider of the service at each date a time weight that represents how strongly the at least one factor contributes to the influence over time; and
generating for the at least one factor and the provider at each date a factor-impact score that represents a weighting of the time weights against the impact score to produce the at least one time vector.

6. The method according to claim 5, wherein defining the at least one time vector further comprises estimating the time weight based on at least one business consideration.

7. The method according to claim 5, wherein defining the at least one time vector further comprises estimating the time weights based on the influence of a stakeholder.

8. The method according to claim 1, wherein the diffusion equation has at least one parameter, and combining comprises making at least one parameter of the diffusion equation a function of time using at least one time vector.

9. The method according to claim 8, wherein the at least one parameter comprises a saturation parameter K and a diffusion parameter p, at least one of which is a function of the at least one time vector.

10. The method according to claim 9, wherein the saturation parameter K is a function of at least an advantage vector and a subscriber utility vector.

11. The method according to claim 9, wherein the diffusion parameter p is a function of a subscriber utility vector, a network utility vector, an advantage vector, and a regulation vector.

12. The method according to claim 1, further comprising using the enhanced diffusion model to provide a prediction of a number of subscribers to a telecommunications service.

13. The method according to claim 1 further comprising using the enhanced diffusion model for at least one of: prioritizing business investment decisions, validating a customer business case, validating a product feature requirement, validating a network solution to ensure adequacy of quality of experience delivery, identifying an emerging service, identifying a rate of adoption, identifying a deployment timeline, identifying a service having the fastest adoption rate, identifying a factor having the most influence on adoption, building a cost model, project profits, predicting a time window for return on investment, and predicting when a late majority occurs.

14. The method according to claim 1 further comprising selecting the service from a class of services based on enabling factors, inhibiting factors, and disrupting factors.

15. The method according to claim 1 further comprising selecting the service based on an advantage of a provider over another provider on account of a type of content of the service.

16. A system for predicting the adoption of a service by subscribers over time comprising:
a memory coupled to a processor, the processor configured to:
for each of at least one influence on the adoption define at least one time vector that represents the influence;
define a diffusion equation that expresses a relationship between the adoption and a rate of change of the adoption; and
combine the diffusion equation and the at least one time vector for each influence to produce an enhanced diffusion model.

17. The system according to claim 16, adapted to define the at least one time vector by:
determining at least one factor that contributes to the influence;
assigning to the at least one factor an impact score that represents the impact of the at least one factor on the adoption;
defining a plurality of dates;
assigning to a provider of the service at each date a time weight that represents how strongly the at least one factor contributes to the influence over time; and
generating for the at least one factor and the provider at each date a factor-impact score that represents a weighting of the time weights against the impact score to produce the at least one time vector.

18. A computer readable medium on which is stored a set of instructions for predicting the adoption of a service by subscribers over time, which when executed performs steps comprising:
for each of at least one influence on the adoption defining at least one time vector that represents the influence;
defining a diffusion equation that expresses a relationship between the adoption and a rate of change of the adoption; and
combining the diffusion equation and the at least one time vector for each influence to produce an enhanced model.

19. The computer readable medium according to claim 18, wherein defining the at least one time vector comprises:
determining at least one factor that contributes to the influence;
assigning to the at least one factor an impact score that represents the impact of the at least one factor on the adoption;
defining a plurality of dates;
assigning to a provider of the service at each date a time weight that represents how strongly the at least one factor contributes to the influence over time; and
generating for the at least one factor and the provider at each date a factor-impact score that represents a weighting of the time weights against the impact score to produce the at least one time vector.
